(19) United States
(12) Patent Application Publication
(10) Pub. No.: US 2014/0096720 A1
(43) Pub. Date: Apr. 10, 2014

(54) Exerciser System for Animals

(71) Applicant: Tanner Bryson, Camp Verde, AZ (US)

(72) Inventor: Tanner Bryson, Camp Verde, AZ (US)

(21) Appl. No.: 14/044,151

(22) Filed: Oct. 2, 2013

Related U.S. Application Data
(60) Provisional application No. 61/710,662, filed on Oct. 5, 2012.

(51) Int. Cl. A01K 15/02

(52) U.S. Cl. CPC A01K 15/027; A01K 15/029
USPC 119/704

(57) ABSTRACT

An animal exerciser system includes a drive cable adjacent to an enclosed exercise course having a path for exercising an animal. Vertical panels are coupled to the drive cable and define an exercise space for confining the animal. Drive wheels move the drive cable longitudinally in a generally horizontal direction to incite an animal within the exercise space to move along the path and through the exercise course. The panels are coupled to the drive cable by flexible couplers and can be configured to give the animal an electric shock to incite it to move. The path can be non-circular, such as a path with straight sections, or non-straight sections of various shapes (e.g, a bend or a zig-zag), and can traverse varying terrain. A control module controls the speed and direction of the movement of the drive cable and can move the drive cable according to a programmed workout routine for the animal.

### RELATED APPLICATION DATA

This application is based on and claims the benefit of U.S. Provisional Patent Application No. 61/710,662 filed on Oct. 5, 2012, the disclosure of which is incorporated herein in its entirety by this reference.

### BACKGROUND

This invention relates to one or more devices, systems, and methods of an exerciser system for animals. Specific examples of embodiments of this invention relate to an exerciser system for animals, such as horses, including one or more panels with flexible connectors configured so that the course or path of the animal can be varied.

Exercise systems for animals typically consist of a circular course or path designed around a central pivot point, For example, conventional walkers for horses are designed to walk the horse in a circle around a central pivot point. The circumference of such a conventional “panel walker” (or European Hot Walker, Eurocizer, Eurociser, or EuroXciser) is determined by the length of the arms radiating from the central pivot to the animal. The central pivot is motor driven, so that it can rotate the central pivot and extending arms to push the animals into motion around the circular course or path.

Such a conventional panel walker can cause repetitive circular motion injuries and stresses to the animal; for example, a horse walking in a 20-foot circle can cause injury or strain to the hip, leg, knee, or hoof on the interior of the circle. Also, such a conventional panel walker does not have an emergency response system; if a horse falls down, trips, is stuck, or is otherwise unable to continue moving, the conventional panel walker cannot sense and respond to such an emergency, such as by stopping the conventional panel walker or calling for help. Such a conventional panel walker is also limited to being placed on a circular flat terrain; for example, the conventional panel walker cannot be placed on a straight, narrow path that may extend 300 feet, a rectangular path that may extend 200 feet, a zigzagged path that may extend in an amorphous or irregular shape, or the like.

It is an object of the present invention to provide an exercise system for animals that overcomes these shortcomings. It is another object of the present invention to provide such a system that can be configured so that the course or path of the animal can be varied, that helps prevent injuries to the animal, that can be placed on varying terrain, and that can include an emergency response system.

Additional objects and advantages of the invention will be set forth in the description that follows, and in part will be apparent from the description, or may be learned by practice of the invention. The objects and advantages of the invention may be realized and obtained by means of the instrumentalities and combinations pointed out in this specification and the appended claims.

### SUMMARY

To achieve the foregoing objects, and in accordance with the purposes of the invention as embodied and broadly described in this document, there is provided an animal exerciser system that includes a drive cable or chain disposed adjacent to an enclosed exercise course having a path for exercising an animal. At least one generally vertical panel is coupled to the drive cable and defines an exercise space for confining the animal. The system includes a drive means for moving the drive cable longitudinally in a generally horizontal direction, so that the panel can incite an animal within the exercise space to move along the path and through the exercise course. In one preferred embodiment of the system, the drive cable comprises an overhead cable, and in another embodiment, the drive cable is disposed at a height below the top of the panel, e.g. at a shoulder height or chest height. The panel is coupled to the drive cable by a flexible coupler. In one embodiment, the panel is configured to give the animal an electric shock sufficient to incite the animal to move. Preferably, the drive means can move the drive cable longitudinally in either direction.

In another embodiment, an animal exerciser system according to the invention includes a drive cable disposed adjacent to an enclosed exercise course having a path for exercising an animal; a rein for coupling the drive cable to the animal; and a drive means for moving the drive cable longitudinally in a generally horizontal direction whereby the rein incites the animal to move along the path and through the exercise course.

According to one aspect of the invention, the exercise course can include a non-circular path for exercising the animal, such as a path that has one or more straight, long sections. In other configurations, the path can include non-straight sections of various shapes, such as a bend or a zig-zag section, and/or can traverse varying terrain.

According to another aspect of the invention, the animal exerciser system includes drive control means for controlling the speed and direction of the movement of the drive cable. The control module can be programmed to move the drive cable according to a programmed workout routine for the animal.

### BRIEF DESCRIPTION OF EXEMPLARY DRAWINGS

Exemplary embodiments of the present invention are described in the context of the appended drawing figures, where like numerals designate like elements:

FIG. 1 illustrates a side view of an animal exerciser system 100 in accordance with an exemplary embodiment of the present invention, showing a drive wheel, an overhead cable, and multiple panels;

FIG. 2 illustrates a top view of the animal exerciser system 100 of FIG. 1, showing the area in which the exercise course is enclosed;

FIG. 3 illustrates a top view of an animal exerciser system 100 in accordance with an exemplary embodiment of the present invention wherein the enclosed area includes a path that bends near the middle;

FIG. 4 illustrates a top view of an animal exerciser system 100 in accordance with an exemplary embodiment of the present invention wherein the enclosed area has partially rectangular shape with half ovals at the ends;

FIG. 5 illustrates a side view of an animal exerciser system 100 in accordance with an exemplary embodiment of the present invention showing placement of the panels to provide enough space between two of the panels for an animal to walk, jog, or run;

FIG. 6 illustrates a side view of an animal exerciser system 100 in accordance with an exemplary embodiment of the present invention showing portions of the enclosed area configured to have a varying terrain;

FIG. 7 illustrates a side view of an animal exerciser system in accordance with an exemplary embodiment of the present invention, showing a control module and a gate for loading animals into and unloading animals from the enclosed area;

FIG. 8 illustrates a side view of an animal exerciser system in accordance with an exemplary embodiment of the present invention, showing the panel positioned to deliver a small electric charge to an animal to urge it to move;

FIG. 9 illustrates a side view of a section of an animal exerciser system in accordance with an exemplary embodiment of the present invention, showing a horse tied to the overhead cable via a rein and a halter, bridle, or other head gear;

FIG. 10 illustrates a top view of an animal exerciser system in accordance with an exemplary embodiment of the present invention, with an entrance gate for allowing animals and trainers to enter or exit the enclosed area;

FIG. 11 illustrates a side view of an animal exerciser system 100 in accordance with an exemplary embodiment of the present invention with an entrance gate implemented using a prefabricated overhead gate;

FIG. 12 illustrates a top view of an animal exerciser system 100 in accordance with an exemplary embodiment of the present invention, wherein the path encircles a hill, boulder, or other obstruction so that the enclosed area has an amorphous or irregular shape;

FIG. 13 illustrates a side view of panel of an animal exerciser system 100 in accordance with an exemplary embodiment of the present invention, showing the panel coupled on the side to waist-high or chest-high cable rather than an overhead cable;

FIG. 14 illustrates a top view of the panel of an animal exerciser system 100 in accordance with the exemplary embodiment of the present invention shown in FIG. 13; and

FIG. 15 illustrates a front view of a control module of an animal exerciser system 100 in accordance with an exemplary embodiment of the present invention.

### DETAILED DESCRIPTION OF EXEMPLARY EMBODIMENTS

The present invention includes an exerciser system for animals in which the course or path the animal takes during exercise may be configured into any suitable shape or dimension. The exercise course or path of the exerciser system of the present invention may be varied to adapt to changing needs of the animal, trainer, or other reason. In one exemplary embodiment of the present invention, the electric panels (e.g., panel 107) that push or urge the animal through the exercise course or path are mounted on a flexible chain, cable, or track (e.g., overhead cable 105). The electric panels 107 are electrically charged and fitted to the chain, cable, or track, so that the electric panels will travel along the exercise course and push the animal in front of them. The present invention allows the animal trainer to design the shape, length, and other details of the exercise course, because the electric panels with the flexible chain, cable, or track can be configured as the animal trainer desires. The layout of the exercise course or path can be any design and over any type of terrain. In addition, the animal trainer can receive input from a veterinarian on ergonomically desirable designs for both the animal and the environment. For example, it may be beneficial for horses to have long straight exercise courses, zigzag courses, large oval courses, or any other shape or configuration. By allowing the veterinarian and the animal trainer to design the exercise course, the exercise system of the present invention can alleviate stress and injury to the animal due to conventional panel walker systems (such as repetitive circular motion injuries and stresses).

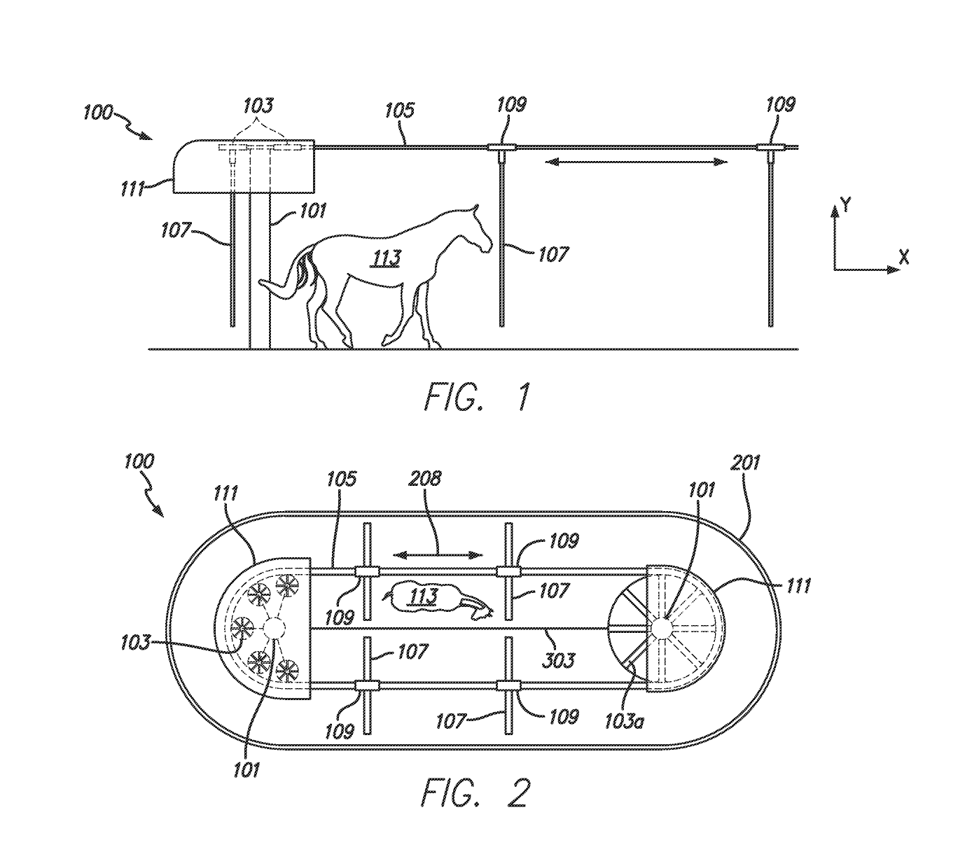

Referring to FIGS. 1 and 2, in accordance with an exemplary embodiment of the present invention, an animal exerciser system 100 includes a support beam 101 (which can be in an upright position or at any angle), one or more driving wheels 103 coupled to the support beam 101, an overhead cable 105 coupled to the driving wheels 103, and a panel 107 coupled to the overhead cable 105 via one or more flexible panel connectors 109. A shroud 111 can be coupled or positioned over the driving wheels 103 and the support beam 101 to cover and protect them. The animal exerciser system 100 can use existing ski lift parts and technology for easy manufacturing of the various components. The connectors 109 preferably are flexible, as explained below, and can move with the chain, or track or cable 105 used to drive the motion of the panels. The connectors 109 can be similar to of not exactly like products used to connect ski lift chairs to their drive cables, In this configuration, the connectors 109 can be sufficiently flexible to allow for movement and sway of panels as they are pulled along by the overhead cable 105.

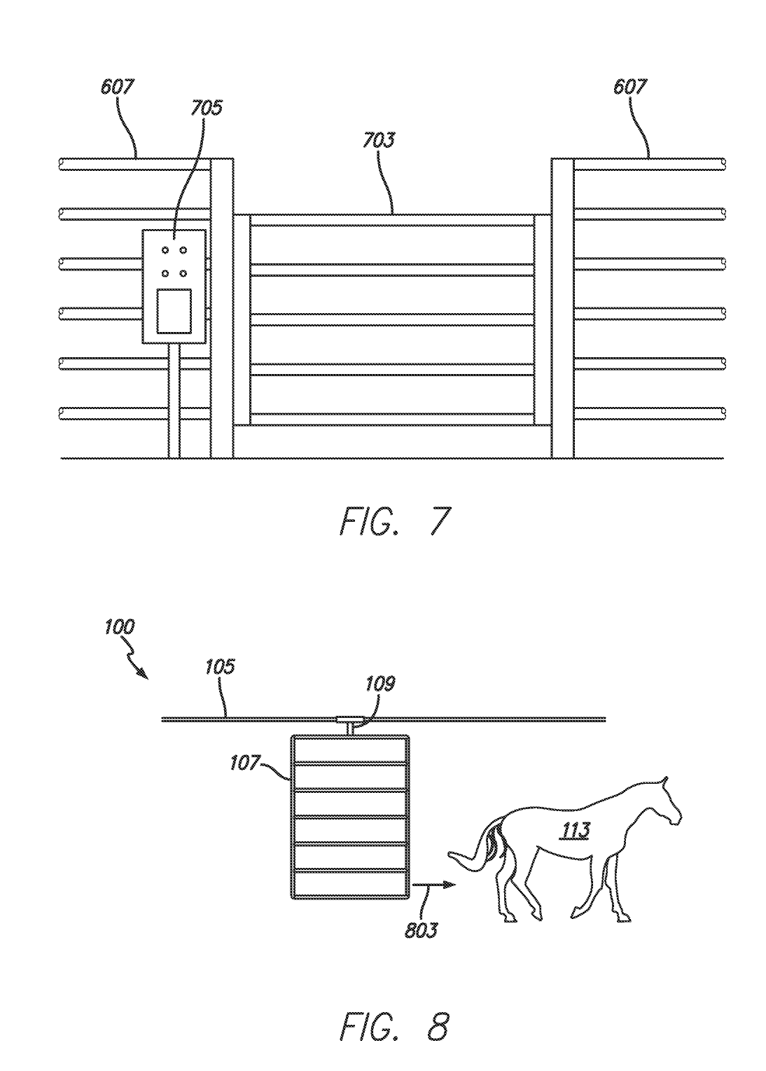

Still referring to FIGS. 1 and 2, a control module 705 or 1500 (illustrated in FIGS. 7, 11 and 15, but not shown in FIGS. 1 and 2) can control the driving wheels 103 and overhead cable 105 to direct the driving wheels 103 and overhead cable 105 to move, so that the panel 107 pushes or incites an animal 113 to move. When power (electrical or other power) is delivered to the driving wheels 103, the driving wheels 103 move the overhead cable 105 (for example, in the x direction (or the reverse direction)) and in turn the overhead cable 105 moves the panel 107 (for example, in the x direction (or the reverse direction)), so that the panel 107 pushes or incites the animal 113 to move (for example, in the x direction (or the reverse direction)). The panel 107 can be an electric panel that gives an electric charge (or small jolt of electricity) to the animal 113 when it contacts the panel 107. The panel 107 does not need to be an electric panel, but rather, the panel 107 can mechanically push or gently nudge the animal 113 to move and exercise. The panel 107 can be mounted onto the overhead cable 105 and preferably is made of a flexible material (or otherwise configured in a way) so that the panel 107 can fold back or flex out of the way in case the animal 113 stops, falls, or gets stuck without being able to move. In addition, since the panel 107 is flexible, it can easily be folded out of the way so that a tractor or other device can condition the footing of the path where the animal 113 exercises. Still further, since the panel 107 is flexible, if the animal 113 gets stalled, falls, or is otherwise unable to move, the panel 107 can simply flex, bend, or fold back, so that the panel 107 can pass the animal 113 without injuring it.

The exemplary embodiment of FIG. 1 illustrates a side view of the animal exerciser system 100. The driving wheels 103 and overhead cable 105 can be configured like driving wheels and overhead cables used in ski lifts and similar technology. In one embodiment, the drive wheel 103 can be made of steel with an outer rubberized rim to grip the cable or chain 105. The drive wheel 103 can be solid or spoked with a center pivot point. It may also have gear-type teeth if a chain 105 is used. The drive wheel or wheels will be similar to, if not exactly the same as, equipment that is used to drive ski lifts chairs. The cable 105 will most likely be braided or twisted steel. Its size will be determined based on the load and capacity necessary for its purpose of supporting and moving the panels 107. As the driving wheels 103 and overhead cable 105 move, the animal 113 is forced to move between one or more panels 107. The space between the one or more panels 107 can be varied depending on the size of the animal 113 or as desired by the trainer. The one or more panels 107 are driven or moved by the overhead cable 105 (coupled or mounted to the one or more panels 107).

The exemplary embodiment of FIG. 1 illustrates coupling one or more panels 107 to the overhead cable 105 via one or more flexible panel connectors 109. Since the flexible panel connectors 109 are flexible, bendable, or otherwise configurable, the panels 107 are not rigid (but instead can flex, bend, or otherwise be configured). Since the panels 107 are not rigid but can flex with the animal 113, it can help prevent injury to the animal 113 (should the animal 113 come to an abrupt stop, trip, become unstable, or fall). Panel 107 can be a prefabricated panel gate, preferably made of a light weight material, such as aluminum, steel or a type of carbon fiber etc. Examples of potentially suitable gates are horse panels or square configured hog panels manufactured by Priefert Manufacturing of Mount Pleasant, Tex., or Powder River, Inc. of Provo, Utah. The panel connector 109 will be most likely me made of steel, cable, and or rubberized material or any combination of those materials.

Referring to FIG. 2, the animal exerciser system 100 is enclosed in an enclosed area 201 and includes the support beam 101, one or more driving wheels 103 and/or a big drive wheel 103a coupled to one or more support beams 101, the overhead cable 105 coupled to the driving wheels 103 and/or big drive wheel 103a, and the panel 107 coupled to the overhead cable 105 via a flexible panel connector 109. A shroud 111 can be coupled or positioned over the driving wheels 103 and/or the big drive wheel 103a and the support beam 101 to cover and protect them. The space between the one or more panels 107 creates an exercise space 208 for the animal 113 and can be varied depending on the size of the animal 113 or as desired by the trainer. The exercise space 208 illustrates the space between the one or more panels 107 from the perspective of where the animal 113 is positioned and the space to the next panel 107 of the enclosed area 201. In this exemplary embodiment, enclosed area 201 is in the shape of a rectangle with semicircular ends, but enclosed area 201 can be virtually any shape depending on the desires of the trainer and the terrain that the animal exerciser system 100 is located on.

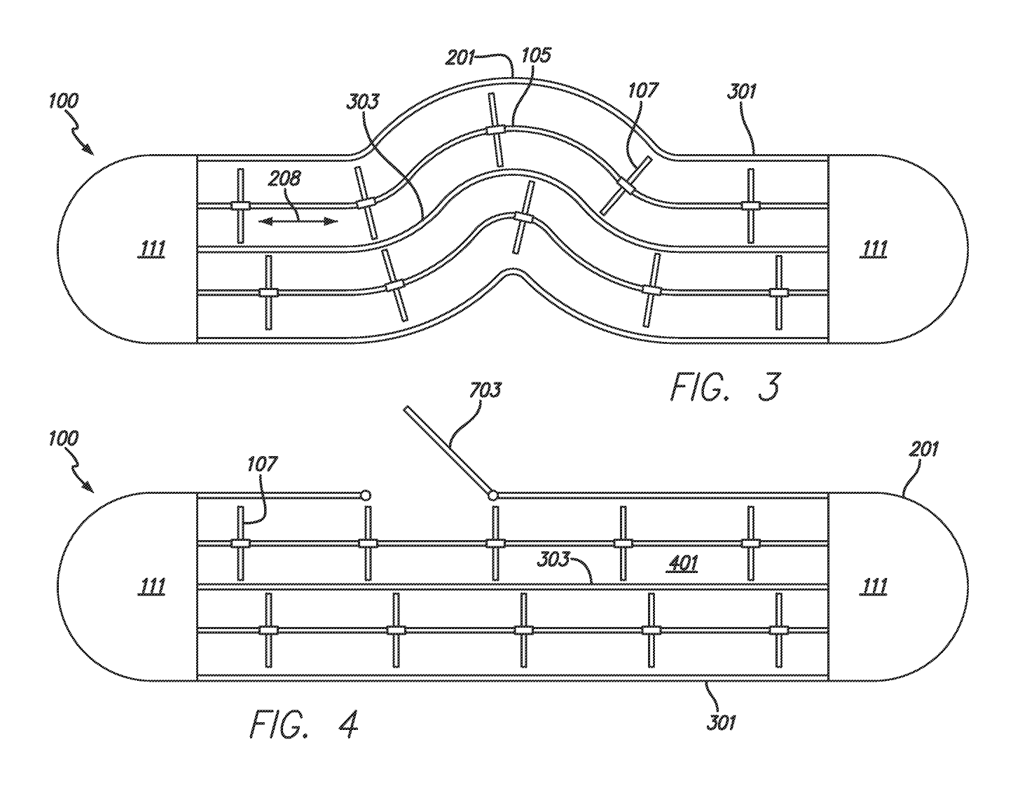

In accordance with an exemplary embodiment of the present invention, as illustrated in FIG. 3 as a top view, an animal exerciser system 100 is enclosed in an enclosed area 201 and includes an exterior fence 301, an interior middle fence 303, the overhead cable 105 coupled to the panel 107, and the shroud 111 coupled or positioned over the driving wheels 103 (not shown) and the support beam 101 (not shown). The exterior fence 301 encloses the enclosed area 201 where the animal 113 (not shown) will exercise. The interior middle fence 303 divides the enclosed area 201, so that the animal 113 can exercise along a path under the overhead cable 105 starting at any point within the enclosed area 201 with the exterior fence 301 on one side of the animal 113 and the interior middle fence on the other side of the animal 113. The animal 113 can exercise in any direction along the path within the enclosed area 201. The panel 107 pushes the animal 113 to move as the overhead cable 105 moves, and as a result, the animal 113 within the exercise space 208 created between the panels 107 moves. The enclosed area 201 in FIG. 3 has a partially rectangular shape with half ovals at the ends where the shrouds 111 are positioned and bends near the middle of the enclosed area 201. It will be understood upon reading this specification, however, that the enclosed area 201 can have any shape and configuration.

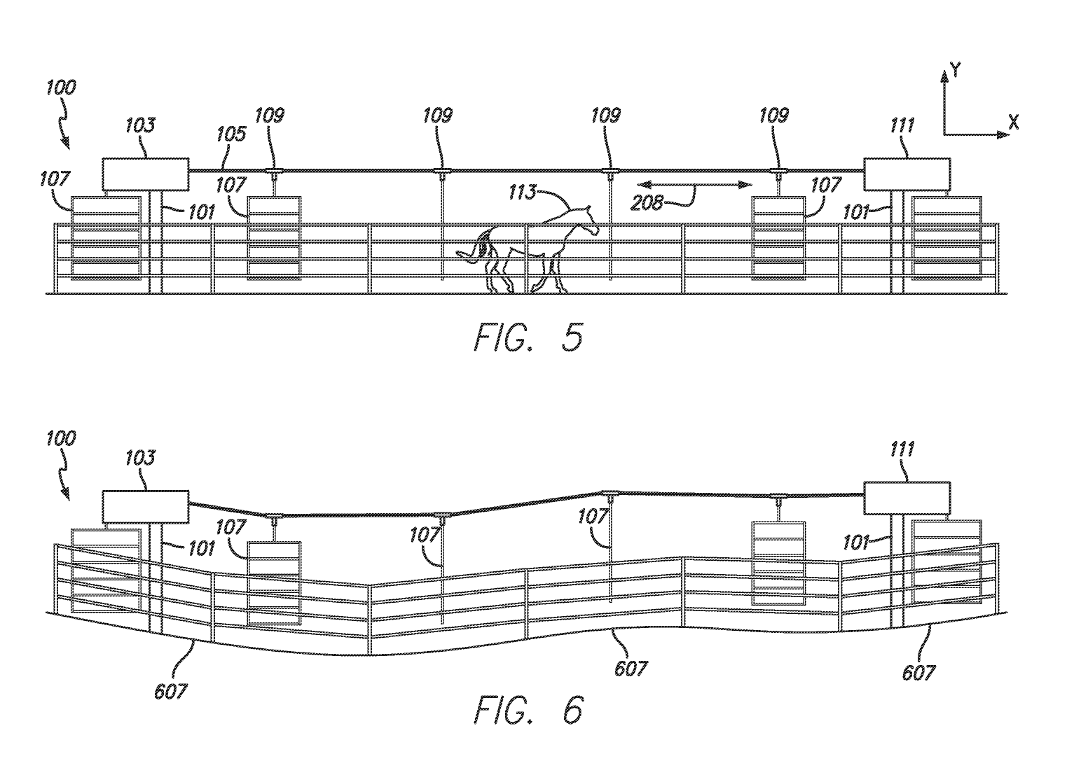

In accordance with an exemplary embodiment of the present invention, as illustrated in FIG. 4 as a top view, an animal exerciser system 100 is enclosed in an enclosed area 201 and includes the exterior fence 301, the interior middle fence 303, the overhead cable 105 coupled to the panel 107, and the shroud 111 coupled or positioned over the driving wheels 103 (not shown) and the support beam 101 (not shown). The exterior fence 301 encloses the enclosed area 201 where the animal 113 (not shown) will exercise. The interior middle fence 303 divides the enclosed area 201, so that the animal 113 can exercise along a path under the overhead cable 105 starting at any point within the enclosed area 201 with the exterior fence 301 on one side of the animal 113 and the interior middle fence on the other side of the animal 113 The animal 113 can exercise in any direction along the path within the enclosed area 201. A compartment 401 (such as the exercise space 208) for the animal 113 is created between two or more panels 107. The panel 107 pushes the animal 113 to move as the overhead cable 105 moves, and as a result, the compartment 401 created between the panels 107 and thus the animal 113 moves. The enclosed area 201 in FIG. 4 has a partially rectangular shape with half ovals at the ends where the shrouds 111 are positioned. The enclosed area 201 can have any shape and configuration.

FIG. 5 illustrates a side view of an exemplary embodiment of the animal exerciser system 100. The animal exerciser system 100 includes the support beam 101 (which can be in an upright position or angled), one or more driving wheels 103 coupled to the support beam 101, the overhead cable 105 coupled to the driving wheel(s) 103, and one or more panels 107 coupled to the overhead cable 105 via a flexible panel connector 109. The shroud 111 can be coupled or positioned over the driving wheel(s) 103 and the support beam 101 to cover and protect them. FIG. 5 illustrates one configuration of placing the panels 107 in order to have enough space (such as exercise space 208) between two of the panels 107 for the animal 113 to walk, jog, or run. The direction in which the one or more driving wheels 103, and consequently, the overhead cable 105, and consequently, the panels 107, and consequently, the exercise space 208 can be in one direction (for example, the x direction) or in another direction (for example, in reverse of the x direction).

The exemplary embodiment of FIG. 6 illustrates a side view of the animal exerciser system 100. The animal exerciser system 100 includes one or more support beams 101 (which can be in an upright position or angled), one or more driving wheels 103 coupled to the support beam 101, the overhead cable 105 coupled to the driving wheel(s) 103, and one or more panels 107 coupled to the overhead cable 105 via a flexible panel connector 109. The shroud 111 can be coupled or positioned over the driving wheel(s) 103 and the support beam 101 to cover and protect them. The side view of the animal exerciser system 100 in FIG. 6 illustrates one configuration of varying the shape of the enclosed area 201 or being able to position the enclosed area over hills and other uneven terrain. This configuration allows for different types of terrain for the animal 113 (not shown) to walk, jog, or run, For example, in FIG. 6, parts of a fence 607 of the enclosed area 201 can be positioned in a zigzag, up and down hilts, or any other shape or configuration to be versatile on differing terrain.

With reference to FIG. 7 and FIG. 15, the animal exerciser system 100 can be located in the enclosed area 201 (not shown) (such as an animal pen). A gate 703, which can be opened to provide an entrance into the enclosed area 201, allows access to the enclosed area 201 so that the animals can be put into or taken out of the enclosed area 201. A fence 607 encloses the enclosed area 201. A control module 1500 includes a control panel 705 for receiving control inputs from an operator of the system, and is mounted on the fence 607 (or alternatively can be located on the animal exerciser system 100 or at another location). The control module 1500 can be configured or programmed to direct the driving wheels 103 to move the cable 105 and panel 107 into motion.

In one embodiment, as shown in FIG. 15, the control panel 705 includes operator switches or buttons and a display screen 1505. Power (electric, solar, or any other power) is delivered to the driving wheels 103 by pushing an on/off power switch 1501 on the control panel 705. When power is delivered to the driving wheels 103 (for example, the control module 1500 turns on the animal exerciser system 100), the driving wheels 103 move the overhead cable 105, and the overhead cable 105 moves the panel 107 so that the panel 107 pushes or incites the animal 113 (not shown) to move. The control module 1500 can also be used to advance the panels 107 in a manual mode (for example, for loading and unloading the animal 113). This manual mode is controlled by an advance manually button 1507 of the control panel 705. The control panel 705 can include an on/off electrify button 1503 for controlling electricity to each panel 107, so that the ability of each panel 107 to deliver an electric charge to the animal 113 can be controlled individually. For example, the first three panels 107 can have the electric charge turned on while the next two panels 107 have the electric charge turned off. As such, the “shocking” ability of each panel 107 can be controlled and programmed individually.

The control module 1500 can control the speed and direction at which the panel 107 moves. The control module 1500 can be configured or programmed, via one or more program buttons 1509 on the control panel 705. For example, the control module 1500 can be configured or programmed with one or more workout routines for the animal 113 (such as 5 minutes walking at 20 minute per mile pace, then 2 minutes jogging at 10 minute per mile pace, then 3 minutes walking at 15 minute per mile pace, then 2 minutes running at 7 minute per mile pace, etc.). The control module 1500 can he configured or programmed to direct the driving wheels 103 to move the overhead cable 105 and panel 107 in one direction, then backwards, and continue to vary. The control module 1500 can he configured or programmed to direct the driving wheels 103 to move the overhead cable 105 and panel 107 at a particular time, to continue for a particular amount of time, and to turn on and off at certain times of the day, week, or month. The control module 1500 can be configured or programmed to direct the panel 107 to include an electric charge or to move at a specified speed (or at varying speeds). The control module 1500 can be configured or programmed to monitor the electric charge and the motion of the animal 113 in case there is an error or emergency, so that the control module 1500 can automatically shut-off and stop the animal exerciser system 100 and alert the trainer that there is a problem. The control module 1500 and control panel 705 can be implemented using a control module and control panel from an existing exercise system with suitable modifications to it to direct the animal exerciser system 100 of the present invention. For example, the control module 1500 can be configured or programmed to include varying workout routines, warm-up routines, and cool down routines for the animals. A start program button 1511 on the control panel 705 can begin one of the workout routines that were previously programmed or configured in the control module 1500.

The exemplary embodiment of FIG. 8 illustrates a partial view of the animal exerciser system 100 including the overhead cable 105 in motion. The panel 107 is coupled to the overhead cable 105 via the flexible panel connector 109. In this embodiment, the panel 107 is electrically charged. When the overhead cable moves, the panel 107 moves. The panel 107 contacts the animal 113 and delivers a small electric charge (illustrated as a charged bolt 803) to the animal 113, so that the animal 113 is incited to move and thereby to exercise. Of course, the panel 107 does not need to be electrically charged; rather, the panel 107 can simply push the animal 113 to move and thereby to exercise. In this way, the panel 107 can have the electric charge on it turned on or off by the trainer via a manual switch located on the animal exerciser system 100 (or alternatively, a switch component integrated into the control panel 705 can be used to turn the electric charge on or off).

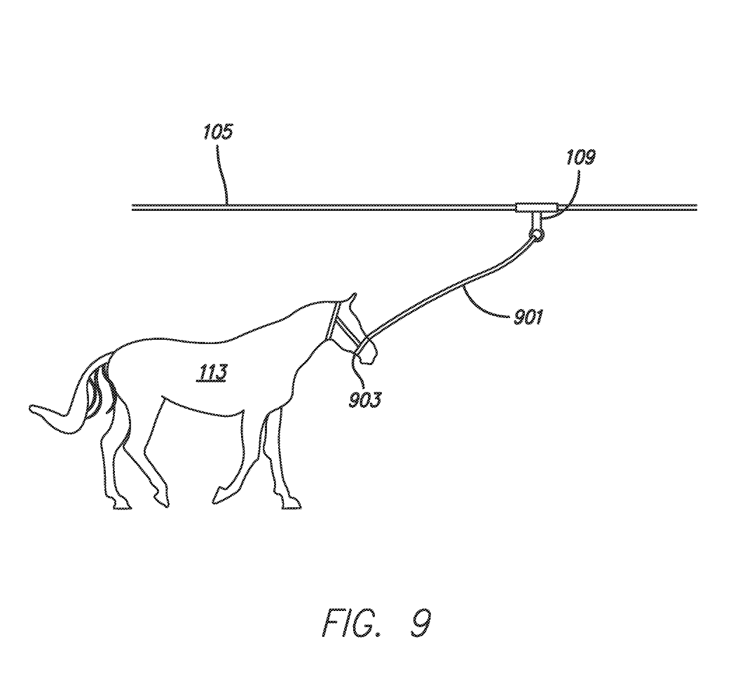

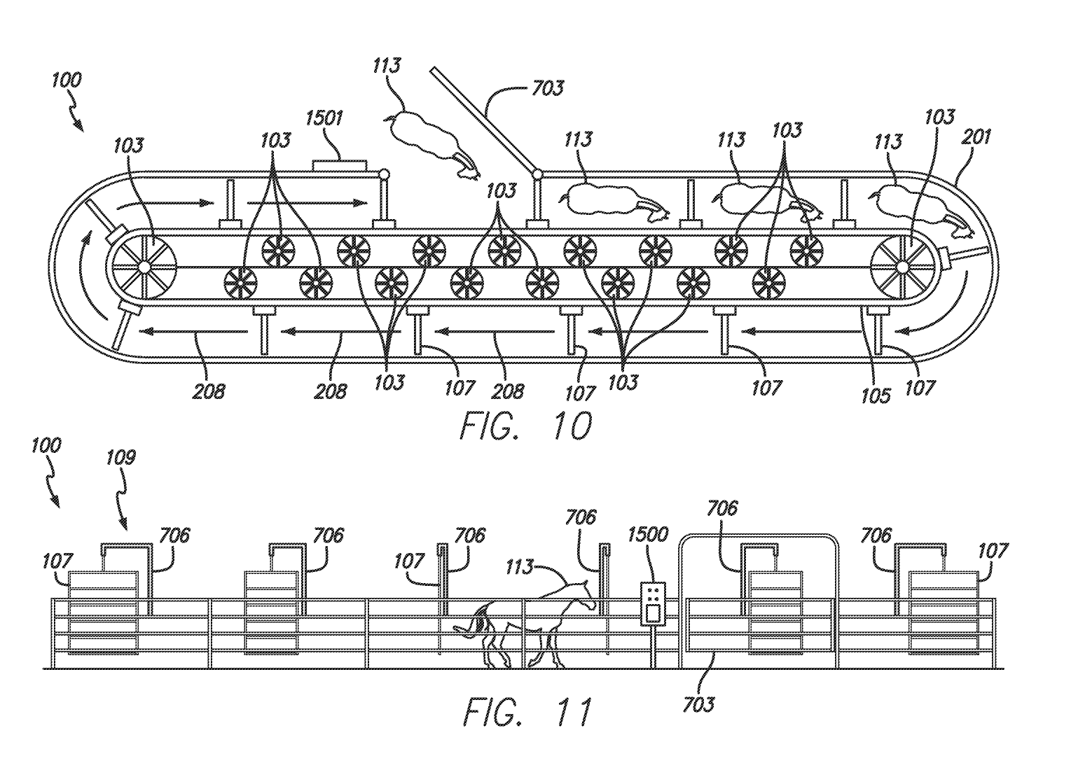

The exemplary embodiment of FIG. 9 illustrates a partial view of the animal exerciser system 100 including the overhead cable 105 in motion without the panel 107. The overhead cable 105 can be coupled to a rein 901 via the flexible panel connector 109 (or any other type of connector). The rein 901 is coupled to the animal 113 via a halter, bridle, or other head gear 903. In this exemplary embodiment, as the overhead cable 105 moves, the rein 901 pulls the animal 113 via the halter, bridle, or other head gear 903 into motion and thereby causes the animal to exercise.

In accordance with an exemplary embodiment of the present invention, as illustrated in FIG. 10 as a top view, an animal exerciser system 100 is enclosed in an enclosed area 201 and includes multiple support beams 101 (not shown) to support multiple driving wheels 103 (each wheel 103 coupled to each support beam 101), the overhead cable 105 coupled to the driving wheels 103, and each panel 107 coupled to the overhead cable 105 via the flexible panel connector 109. The entrance gate 703 allows entry and exit of the enclosed area 201 by the animal(s) 113 or trainer (not shown). The space between the one or more panels 107 creates an exercise space 208 for the animal 113 and can be varied depending on the size of the animal 113 or as desired by the trainer. The exercise space 208 illustrates the space between the one or more panels 107 from the perspective of where the animal 113 is positioned and the space to the next panel 107 of the enclosed area 201. In this exemplary embodiment, enclosed area 201 is in the shape of a rectangle with semicircular ends, but enclosed area 201 can be virtually any shape depending on the desires of the trainer and the terrain that the animal exerciser system 100 is located on.

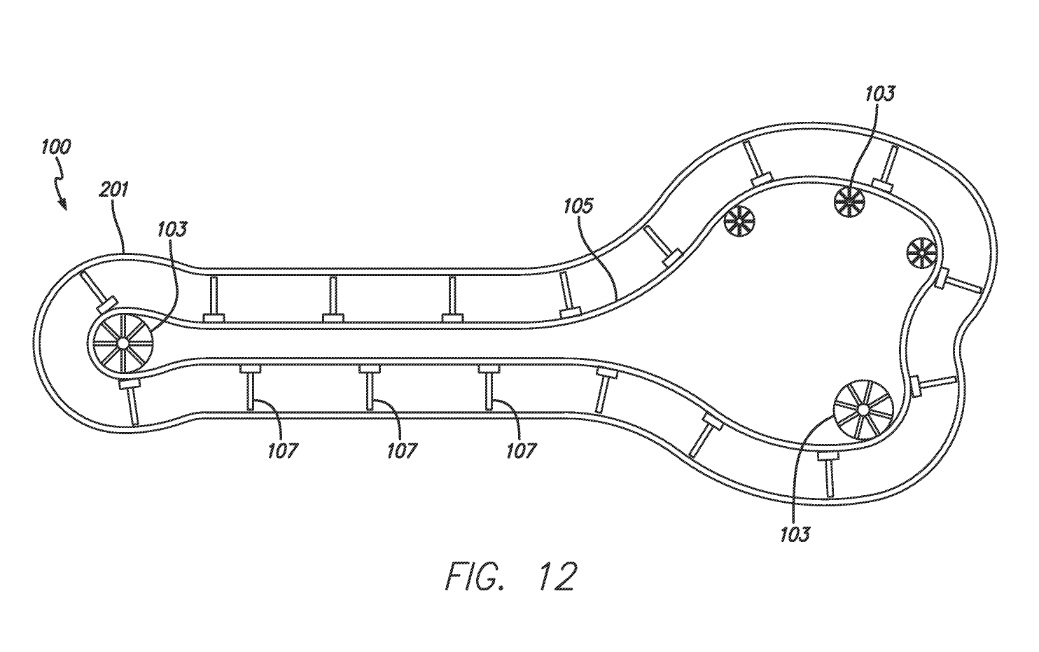

The exemplary embodiment of FIG. 11 illustrates a side view of the animal exerciser system 100, which includes multiple support beams 101 (not shown) to support multiple driving wheels 103 (not shown). In this embodiment, as described below in more detail below with respect to FIG. 12, the panel is attached to a cable 105 that is waste or chest high, rather than an overhead. The animal exerciser system 100 includes a panel support arm 706 coupled to the panel 107 via the flexible panel connector 109. The side view of the animal exerciser system 100 in FIG. 11 illustrates one configuration of placing the panels 107 in order to have enough space between two of the panels 107 for the animal 113 to walk, jog, or run. The area to the right of 1500 on FIG. 11 shows an entry gate 703 into the enclosed area 201 implemented using a prefabricated overhead gate.

In accordance with an exemplary embodiment of the present invention, as illustrated in FIG. 12 as a top view, an animal exerciser system 100 is enclosed in an enclosed area 201 and includes multiple support beams 101 (not shown) to support multiple driving wheels 103 (each wheel 103 coupled to each support beam 101), the overhead cable 105 coupled to the driving wheels 103, and each panel 107 coupled to the overhead cable 105. In this exemplary embodiment, enclosed area 201 is in an amorphous or irregular type of shape, but enclosed area 201 can be virtually any shape depending on the desires of the trainer and the terrain that the animal exerciser system 100 is located on. For example, this type of amorphous shape may be used where there may be a hill, boulder, or other obstruction, so that the animal exerciser system 100 can go around, over, or under these types of obstructions.

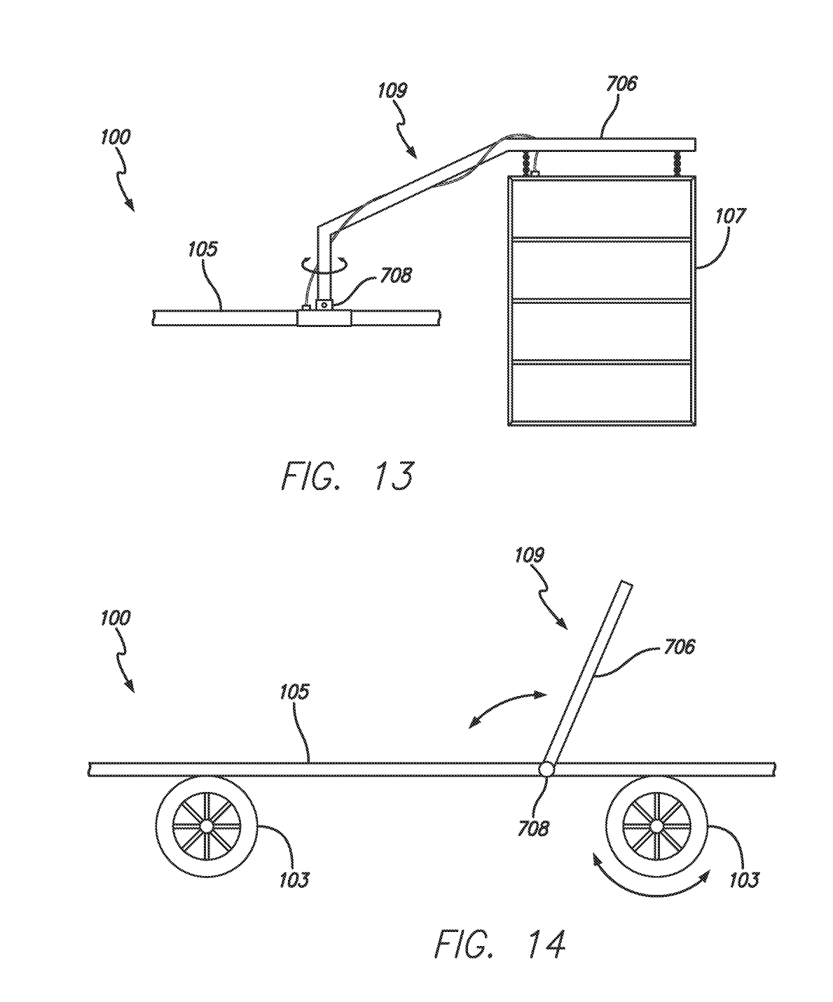

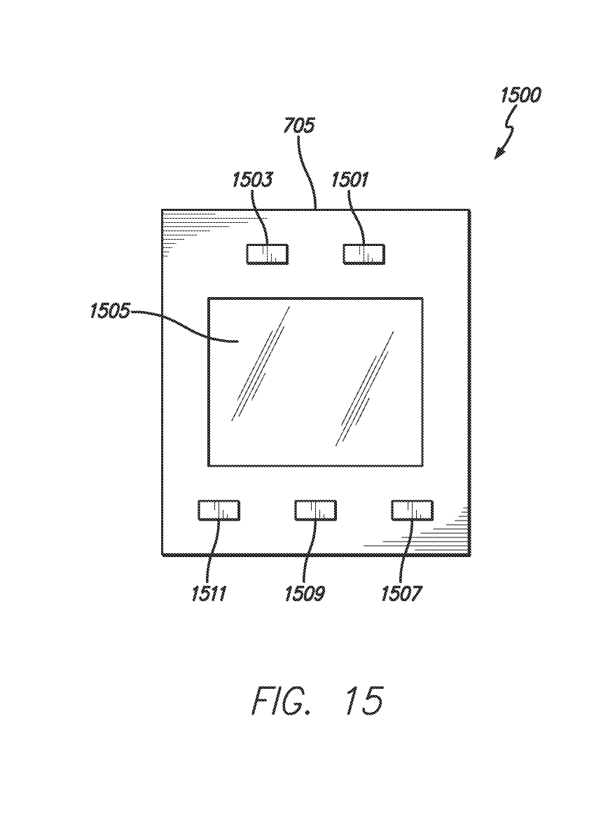

FIG. 13 illustrates a side view of a panel 107 coupled to a cable 105 of an animal exerciser system 100 in accordance with an exemplary embodiment of the present invention. FIG. 14 illustrates a top view of the animal exerciser system 100 of FIG. 13 and shows one possible embodiment of a panel attachment to the cable 105 having a flexible connector. A support arm 706 is coupled to the cable 105 via a swivel or sway component 708 to allow movement. An electric supply to the panel is provided for a shocking to keep animals moving. In this embodiment, the panel 107 is attached to a cable 105 that is waist or chest high rather than overhead.

The animal exerciser system 100 of the present invention can be configured as a long straight path (or course) of any distance, a rectangular path (or course), an oval path (or course), or any other configuration or shape. Since the animal exerciser system 100 has flexible panel connectors 109 and easy to exchange panels 107, the shape or configuration of the path or course for which the animal 113 will exercise can be easily changed. The ability to select the shape of the path or course and change the shape of the path or course reduces injuries caused by repetitive motion to the animal 113. The animal exerciser system 100 can accommodate one or more animals and can be expanded or contracted depending on the number of animals that need to have exercise at one time. The conventional “panel walker” is limited in the number of animals that can exercise (depending on the size of the circle the panel walker has). The animal exerciser system 100 of the present invention is not limited in this way. The animal exerciser system 100 of the present invention is also light weight and inexpensive to build.

In a presently preferred embodiment, the support beam 101 can be made of a prefabricated steel beam or pipe or post. It will be understood after reading this disclosure, however, that the support beam could be constructed of other suitable materials such as concrete or brick, or wood. It could be anything common and exemplifying the structural strength to hold up the motorized driving wheels and cable tension. The one or more driving wheels 103 can be made of sprockets or gears designed to accommodate and move along the cable and or chain or track from which the panels are hung or coupled. The overhead cable 105 can be made of common cable, chain or track such as that which is being used or could be used in a ski lift application. The panel 107 can be fabricated from a light-weight metal (or from any other suitable light-weight material) and can be configured as horizontal bars or in a square or crisscross configuration with a square or rectangular exterior frame. The flexible panel connector 109 can be made flexible with a swivel and or rubberized component to allow for movement and sway. For example, one embodiment could be a design similar to that of the arm attachment from a ski lift chair to the drive cable. The shroud 111 is designed for aesthetics and safety to hide and protect moving components, motors, etc. It can be fabricated out of a molded metal, a fiber glass, or a polycarbonate material, but it is not limited to these materials.

In the foregoing specification, the invention has been described with reference to specific embodiments. However, it will be appreciated that various modifications and changes can be made without departing from the scope of the present invention as set forth in the claims below. The specification and figures are to be regarded in an illustrative manner, rather than a restrictive one, and all such modifications are intended to be included within the scope of present invention. Accordingly, the scope of the invention should be determined by the appended claims and their legal equivalents, rather than by the examples given above. For example, the steps recited in any of the method or process claims may be executed in any order and are not limited to the order presented in the claims.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

1. An animal exerciser system comprising:
a drive cable disposed adjacent to an enclosed exercise course having a path for exercising an animal;
at least one generally vertical panel coupled to the drive cable and defining an exercise space for confining the animal; and
a drive means for moving the drive cable longitudinally in a generally horizontal direction wherein the panel can incite an animal within the exercise space to move along the path and through the exercise course.

2. The animal exerciser system of claim 1 wherein the drive cable comprises an overhead cable.

3. The animal exerciser system of claim 1 wherein the drive cable comprises a cable that is disposed at a height below the top of the panel.

4. The animal exercise system of claim 1 wherein the panel is coupled to the drive cable by a flexible coupler.

5. The animal exerciser of claim 1 wherein the panel is configured to give the animal an electric shock sufficient to incite the animal to move.

6. The animal exerciser of claim 1 wherein the drive means can move the drive cable longitudinally in either direction.

7. The animal exerciser of claim 1 wherein the exercise course includes a path that traverses varying terrain.

8. The animal exerciser of claim 1 wherein the exercise course includes a path having a straight section for exercising the animal.

9. The animal exerciser of claim 1 further comprising a control module for controlling the speed and direction of the movement of the drive cable.

10. An animal exerciser system comprising:
a drive cable disposed adjacent to an enclosed exercise course having a path for exercising an animal;
at least two generally vertical panels coupled to the drive cable and defining an exercise space between the panels for confining the animal; and
a drive means for moving the drive cable longitudinally in a generally horizontal direction wherein when the animal is within the exercise space, at least one of the panels can incite the animal to move along the path and through the exercise course.

11. The animal exerciser of claim 1 wherein the panel is configured to give the animal an electric shock sufficient to incite the animal to move.

12. The animal exerciser of claim 1 wherein the drive means can move the drive cable longitudinally in either direction.

13. The animal exerciser of claim 1 further comprising a control module for controlling the speed and direction of the movement of the drive cable.

14. The animal exercise system of claim 13 wherein the control module is programmed to move the drive cable according to a programmed workout routine for the animal.

15. An animal exerciser system comprising:
a drive cable disposed adjacent to an enclosed exercise course having a path for exercising an animal;
a rein for coupling the drive cable to the animal; and
a drive means for moving the drive cable longitudinally in a generally horizontal direction whereby the rein incites the animal to move along the path and through the exercise course.

16. The animal exerciser system of claim 15 wherein the drive cable comprises an overhead cable.

17. The animal exerciser of claim 15 wherein the drive means can move the drive cable longitudinally in either direction.

18. The animal exerciser of claim 15 wherein the path traverses varying terrain.

19. The animal exerciser of claim 15 wherein the path includes a straight section for exercising the animal.

20. The animal exerciser of claim 15 further comprising a control module for controlling the speed and direction of the movement of the drive cable.
